(19) United States
(12) Patent Application Publication
(10) Pub. No.: US 2014/0280833 A1
(43) Pub. Date: Sep. 18, 2014

(54) SYSTEM AND METHOD FOR EFFICIENTLY MANAGING NETWORK CHANGES

(71) Applicants: LINGPING GAO, BURLINGTON, MA (US); Guangdong Liao, Toronto (CA)

(72) Inventors: LINGPING GAO, BURLINGTON, MA (US); Guangdong Liao, Toronto (CA)

(21) Appl. No.: 13/842,222

(22) Filed: Mar. 15, 2013

(51) Int. Cl. H04L 12/24

(52) U.S. Cl. CPC H04L 41/0213
USPC 709/223

(57) ABSTRACT

Methods and system for managing network changes. A network change cycle is divided into a multi-stage cascade of events. User interfaces are provided to define and manage each stage of events. Before a change is executed, a network state is benchmarked. Change results are saved into various data folders for comparison. Rollback utilities are provided to rollback the change to a particular event in a timeline.

### BACKGROUND

The present application relates to network management, and more particularly to a visual system and method for efficiently managing network changes.

Note that the points discussed below may reflect the hindsight gained from the disclosed inventions, and are not necessarily admitted to be prior art.

The network system gets more and more complex. Today's businesses rely heavily on a stable network system. Initiating, planning, constructing and conducting a network change can incur serious consequences. Unintended interruption of a network system may collapse an entire working environment, causing hundreds of thousands of dollars in losses and delays. However, vast network systems have been in constant dynamics of change, re-configuration and upgrading, in numerous nonstop endeavors to provide new services and satisfactions to the ever-changing waves of customer needs.

Generally, a task of conducting a network change often includes four major steps: plan, design, implementation and verification. So far, these steps have been mainly performed manually. There is no efficient way to assure that a network change does not cause network problems. In fact, the majority of network problems are caused by network changes.

There is an urgent need for a system and method that conducts reliable and efficient network changes, for network management.

### SUMMARY

The present application discloses new approach and system for conducting a network change. A system is invented to manage a network change task from beginning to end. The system first designs a work flow to greatly reduce possible problems that may be caused by a network change. By providing visual user interfaces and methods, the system streamlines a network change into various stages with safeguards of benchmarked data verification.

In one embodiment, the status of a network before a proposed change is benchmarked. After executing a planned change, the status of the network after the change is benchmarked. Then the status of the network before and after the change is compared in detail and documentation on the change is created. With the safeguards of data verification, any hazardous change can be instantly rolled back without causing any serious harm.

In one aspect of an embodiment, a time line of events is provided, and all actions or subtasks are recorded. A network change task can also be saved as a standalone file and exported to a Word document for review.

The inventions provide GUIs to guide a user through and perform a reliable network change. Using NETBRAIN™ Workstation in connection with any network system, a user can conduct the entire process from initiating to finalizing a network change in an orderly manner.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 illustrates an example management system for conducting network changes in accordance with this application.

FIG. 2 shows an example work flow for conducting a network change in accordance with this application.

FIG. 3 shows an example user interface for implementing and conducting a network change in accordance with this application.

FIG. 4 shows an example of timeline interface in accordance with this application.

FIG. 5 shows an example method and user interface for defining a configuration change template in accordance with this application.

FIG. 6 shows an example method and user interface for defining a configuration change for a network device in accordance with this application.

FIG. 7 shows an example method and user interface for benchmarking subtasks in accordance with this application.

FIG. 8 shows an example user interface for adding benchmarked commands via a template in accordance with this application.

FIG. 9 shows an example method and user interface for executing a configuration change in accordance with this application.

FIG. 10 shows an example user interface for comparing network status before and after a change in accordance with this application.

FIG. 11 shows the contents to be exported in a Word document

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The present application may be described herein in terms of functional block components and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting languages such as C, C++, Java, COBOL, assembler, PERL, Python, or the like, with the various algorithms being implemented with any combination of data structures, objects, processes, routines, or other programming elements. Further, it should be noted that the present invention may employ any number of conventional techniques for data transmission, signaling, data processing, network control, and the like.

A particularly powerful tool for understanding network behavior is graphic visualization. According to one embodiment, a graphical representation of the network may be output to a display screen, printer, plotter, or the like. Background technologies and terminologies are further described in U.S. Pat. No. 8,386,593, the content of which is incorporated by reference.

Generally, a task of conducting a network change often includes four major steps: plan, design, implementation and verification. So far, these steps have been manually performed via text based CLI commands and Word/Visio documents manually.

The present application provides a systematic approach to manage a network change task. The system designs a work flow to automate many subtasks and greatly reduce possible problems that may be caused by a network change.

FIG. 1 is a schematic block diagram showing the relevant components of a network change management system. The system includes a user interface 101 to define a network change task 103 from beginning to end. A network change task is divided into clearly defined subtasks or action items. The history of each action or subtask is recorded in a time line (or timeline, both are used inter-exchangeably). A network change task can be saved at any stage as a self-contained file, which can be sent to anyone for the purpose of peer review or proof of a change.

A network change task can be subsequently instructed to send CLI commands 105 to network devices to execute the network change or collect the benchmarked data. Documents can be created for a network management task. In an example implementation, a Word document 104 may be created, though other formatting options, such as a PDF file can be also created.

FIG. 2 outlines a work flow for conducting a change management. Following this best practiced workflow can greatly reduce the problems or errors caused by a network change. The flow has the following steps: the first step 210 is to define the planned network change. A user defines what is going to be changed, for example, what configurations are to be modified. In this step the user may also define what devices are to be impacted by this planned change. Since all network devices are connected, the planned network change may not only affect the target devices but also affect other related devices. For example, the configuration change of a dynamic routing protocol such as EIGRP in a router will affect the routings of its EIGRP neighbor routers.

The next step 220 is to benchmark the network states for the modified and potentially impacted devices before the change. This benchmarked data will be used to compare with the data benchmarked after the change.

Next, the user can execute the change at step 230. He can instruct the system to automatically log into the devices and issue CLI commands to execute the change. The user can view the execution process, stop and/or continue the process anytime. Or, he can rollback the change and make modifications on the plan.

After the change is executed, another benchmarking process (step 240) is run to collect the network state. The benchmarked data before and after the change are now compared in step 250. Visual user interface is provided in which the differences are highlighted and displayed. After analyzing the difference, the user can decide whether the results are acceptable. If the results indicate a problem was introduced by the change, the user can go back to step 230 and roll back the configuration changes.

In step 260 the benchmarking task can be imported to a document. The user can select what data is to be included in the document. In a preferred implementation, a Word document is created. Other formats may be selected at the user's preference.

FIG. 3 is a user interface to implement the workflow illustrated in FIG. 2. The flow chart 310 shows the subtasks or action items in the order of time. The first subtask, the summary subtask 312, is for a general description of the task and can include a topology map 334 to show the network devices to be changed or to be affected by the change. Other subtasks, Define Network Change 313, Benchmark Before 314, Execute 315, Benchmark After 316, Compare 317, and Document 318 comprise a full circle for managing a network change, as illustrated in FIG. 2.

The order of each subtask in the flow chart is recommended but not mandatory. The user can skip a subtask or jump to any subtask. A subtask can also be repeated many times. In fact, for a complex network change task, a user often needs to go through the flow a few times to get satisfactory results.

A timeline 320 shows the history of the network change task. Each node of the timeline corresponds to an action or an executed subtask. The timeline is automatically updated after a subtask or an action is finished.

The details of the current subtask are displayed in the work window 330. For example, for the summary subtask 312, the description and map 334 are displayed.

FIG. 4 is an example of the timeline. The nodes in the time line are the executed subtasks or actions of a network task in the order of time. Any reviewing action, benchmarking, or execution tasks are displayed in the timeline.

The first node 410 shows the time the task is created. The second node 420 shows a completed benchmarking task. Moving mouse over node 420 brings up a tip window 430 showing the details of the benchmarking task: the executed time of the benchmarking, the number of devices on which the benchmarking task was executed, and the number of CLI commands that were issued. Right click the node 420 and the operations which can be performed on a node are displayed in the menu 440. The operations may be different for different types of subtasks. The “History Review . . . ” menu 442 will display the benchmarked result status in the work window. The “Set as First DataFolder” menu 444 and “Set as Second DataFolder” 446 will set the benchmarked results as the data source for the comparison subtask. A DataFolder is an alias of the file folder while the benchmarked data are stored. The delete menu 448 removes this node as well as the historical record from the time line.

The time line is a good way to understand the history related to a network change task. Particularly, the time line can be used to show the proving process of a task. Click the button “History . . . ” 450 and the user can add a review task 455. In this task, he can prove or reject a network change. The review task is added as a node 460 in the time line.

FIG. 5 shows how a user defines a network change. The devices to be changed, added, removed, upgraded and impacted are listed in pane 510. The right click menu is provided for the user to select or unselect the devices.

The majority of network changes are configuration changes that are executed through the CLI interfaces. The config template window 520 provides a way to create a template of configuration changes which can be applied to all devices to be changed. The template 530 supports the normal configuration commands such as:

config t

ntp server 10.10.10.100

The first command is used to enter the configuration command and the second command configures the NTP server. The template also supports a special syntax to auto-create the same configurations for a list of interfaces. For example:

<interface f*

duplex auto>

This template is used to create the configuration “duplex auto” for all interfaces with the name starting with the letter “f.” After the template is applied to a particular device, it may create the following configurations for example:

interface FastEthernet0/0

duplex auto

interface FastEthernet0/1

duplex auto

The auto-created configurations are displayed in pane 540.

FIG. 6 is a configuration change for an individual device. Pane 610 shows the configurations to be entered in device 601. Configurations are edited in this space. Pane 620 shows the rollback configurations. Rollback configurations are useful in the case where a specific change causes a serious problem on the network. In one implementation, rollback configurations can be automatically created. However, a user can always edit the rollback configurations.

It is critical to provide the rollback configurations for a network management task. Due to the complexity of the modern network, a change can often lead to unexpected results and the rollback configurations can be applied in case the problem cannot be resolved quickly.

FIG. 7 shows an example interface for performing a Benchmarking subtask. Benchmarking means screenshot of a network state. Generally it is about the states of the target device and its neighbor devices. A user may add a list commands and devices to represent a network state. Network professionals usually use CLI commands to check the network state. It is not efficient and error prone to manually collect the data before and after a network change. This invention provides an automatic and systematic way to collect system state data before and after a change.

The benchmarked CLI commands are listed in pane 710, as well as the execution results for each device. Two types of data, configuration file 720 and route table 730 are always retrieved since they will often change. Other CLI commands can also be retrieved. In this example, the CLI commands 740 related to the EIGRP routing protocols, “show ip eigrp neighbors”, “show ip eigrp summary” and “show ip eigrp interfaces” are also benchmarked.

The commands to be benchmarked can be added individually (760) or via a template (750). The template defines a list of CLI commands which should be checked for a type of network change task according to best practices.

FIG. 8 shows a user interface to edit and apply the CLI command template. The examples shown here are the CLI commands which should be benchmarked for a network change related to BGP routing protocol: “show ip bgp summary”, “show ip route summary”, “show ip bgp neighbors” and “show ip bgp peer-group”.

FIG. 9 is a user interface to execute CLI commands. The system provides three options to execute commands. With the option “All at Once” 910, the system will execute all CLI commands on all devices without pause. With the option “Device by Device” 912, the system will pause after executing the CLI commands on one device and will only continue on the next device after the user clicks the execution button 920. With the option “Line by Line” 914, the system will pause after executing one line and will continue the next line after the user clicks the execution button.

The stop button 922 is provided to allow a user, at any time, to prevent the system from executing the commands further. The execution button 920 is also used to instruct the system to continue the execution.

The window 930 is the telnet/SSH window showing how the system logs into the device and issues CLI commands. All commands that the user defines in step 2 will be automatically issued on the device. The execution log 940 shows how the system logs into the device and all CLI commands issued to the device.

The pane 950 shows the execution status for each CLI command and pane 960 shows execution status for each device. The status is completed if all CLI commands are executed successfully. If any error occurs, such as where a device cannot be accessed, an error will be reported in window 960.

FIG. 10 shows how to run the Comparison subtask. The comparison subtask compares the benchmarked data before and after the change. The differences will be highlighted so that the user can easily see what differences the network change makes.

If the user runs the benchmarking task before and after the change, the folder to store these two benchmarked data are automatically selected as the data source to be compared in the first DataFolder 1010 and the second DataFolder 1020. The user can also select other data sources available in the system to be compared.

The comparison results of the benchmarked data including the configuration files, route tables, and CLI command results are summarized in the pane 1030 under the different tags. For the configuration files, the summary shows whether or not the configuration file for each device has been changed. Double click an entry to show the configuration difference.

The configuration differences are highlighted in window 1040. In this example, the system provides two buttons, “Next” 1050 and “Previous” 1060 for a user to quickly find the next or last configuration difference.

The comparison of route tables and other CLI commands are displayed in a similar fashion. By looking through these differences, the user can quickly find out whether the network change leads to the expected results or any unexpected side effect. If he is not satisfied with the result, he can either execute the rollback configurations to roll back his change or define another network change.

The network management task can be saved as a self contained document. This document can be sent to another user for review. The other user can open the document by the change management system. If the other user does not have the change management system installed in his PC, the task can be imported to a popular document format, such as a Word document.

FIG. 11 shows the contents the user can select to export. By checking the “Review History” option 1110, the system will export a review history table like this:

Review History

| Issue | Date | Author | Comments |
|---|---|---|---|
| Created | 2012/8/20 | John | create change management task |
| Reviewed | 2012/8/22 | Smith | Approved |

By checking the “Implementation History” option 1120, the system will export an implementation history such as:

Implementation History

| Issue | Date | Author | Comments | Zipped Data |
|---|---|---|---|---|
| Benchmark | 2012/8/23 | Nick | 50 Devices, | 300 Show commands |
| Execute | 2012/8/23 | Nick | | Configlet in Changel |

If the user checks the “Attach Zipped File of DataFolder and Log” option 1130, the data and the execution log will be zipped and attached into the zipped data column.

Similar data will be exported under other categories: Summary 1140, Export Map 1150, and Change and Config Change and Result 1160. Most data are exported as table formats for easy reading.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A network management system for managing a network change, comprising:
a visual cascade of managed steps for a full cycle of conducting a network change wherein each of said managed steps includes a corresponding set of functionalities;
a visual timeline for displaying an action occurred in real time; and
a set of functions for rolling back a network change to a previous state.

2. The network management system of claim 1, wherein
said managed steps include a step of defining a change, a step of Benchmarking network state before a change, a step of executing a change, a step of Benchmarking network state after a change, a step of comparing network change results and a step of documentation.

3. The network management system of claim 2, wherein said step of defining a change includes selecting a set of devices, and editing a Command template in an editing pane.

4. The network management system of claim 2, wherein said steps of Benchmarking network state before and after a change includes automatically retrieving configuration files and route table.

5. The network management system of claim 2, wherein said steps of Benchmarking network state before and after a change includes automatically retrieving any CLI commands added individually or via a template.

6. The network management system of claim 2, wherein said step of executing a change includes an option to execute all at once, an option to execute device by device, and an option to execute line by line, and a function to stop execution.

7. The network management system of claim 2, wherein said step of comparing network change results includes an option to select a datafolder containing a set of data for a particular execution timeline.

8. The network management system of claim 2, wherein said step of documentation includes an option to convert a network change task into another format.

9. The network management system of claim 1, wherein the said timeline records a review node, an execution of a benchmarking task, an execution of network change task in according to time sequence.

10. A method for managing a network change, said method comprising the steps:
dividing a full cycle of conducting a network change into a visual cascade of managed steps;
providing a corresponding set of functionalities for each of said managed steps;
providing a visual timeline to display an action occurred in real time; and
providing a set of functions for rolling back a network change to a previous state.

11. The method of claim 10, wherein
said managed steps include a step of defining a change, a step of Benchmarking network state before a change, a step of executing a change, a step of Benchmarking network state after a change, a step of comparing network change results and a step of documentation.

12. The method of claim 11, wherein said step of defining a change includes selecting a set of devices, and editing a Command template in an editing pane.

13. The method of claim 11, wherein said steps of Benchmarking network state before and after a change includes automatically retrieving configuration files and route table.

14. The method of claim 11, wherein said steps of Benchmarking network state before and after a change includes automatically retrieving any CLI commands added individually or via a template.

15. The method of claim 11, wherein said step of executing a change includes an option to execute all at once, an option to execute device by device, and an option to execute line by line, and a function to stop execution.

16. The method of claim 11, wherein said step of comparing network change results includes an option to select a datafolder containing a set of data for a particular execution timeline.

17. The method of claim 11, wherein said step of documentation includes an option to convert a network change task into another format.

18. The method of claim 11, wherein the said timeline records a review node, an execution of a benchmarking task, an execution of network change task in according to time sequence.
